(19) United States
(12) Patent Application Publication
(10) Pub. No.: US 2026/0294723 A1
(43) Pub. Date: Oct. 1, 2026

(54) MAGNETIC ATTACHMENT ASSEMBLIES FOR DISPLAY ELEMENTS

(71) Applicant: Batesville Services, LLC, Batesville, IN (US)

(72) Inventor: Gregory William Wray, Guilford, IN (US)

(73) Assignee: Batesville Services, LLC, Batesville, IN (US)

(21) Appl. No.: 19/577,851

(22) Filed: Mar. 25, 2026

Related U.S. Application Data
(60) Provisional application No. 63/779,449, filed on Mar. 28, 2025.

(51) Int. Cl. A61G 17/04; G09F 7/18

(52) U.S. Cl. CPC A61G 17/04; G09F 7/18; A61G 2205/30; G09F 2007/1852; G09F 2007/1856

(57) ABSTRACT

Disclosed herein are magnetic attachment assemblies including a display layer and a support layer having a front surface and a rear surface opposite the front surface, the support layer including a rear magnet provided on the rear surface, a stand attachable to the rear surface, and a pair of mounting apertures formed in the rear surface. The display layer is magnetically attachable to the front surface of the support layer.

### CROSS-REFERENCE TO RELATED APPLICATION

This application claims the benefit of co-pending U.S. Provisional Patent Application No. 63/779,449, filed Mar. 28, 2025, for “Magnetic Attachment Assemblies For Display Elements,” which is hereby incorporated by reference in its entirety including the drawings.

### TECHNICAL FIELD

The present specification generally relates to apparatuses and methods for displaying items on a casket and, more specifically, magnetically attaching items to a casket lid.

### BACKGROUND

Casket assemblies may include surfaces that on which an item such as displays, nameplates, or other decorative elements may be removably attached. Traditional fastening methods sometimes fail to provide quick, reliable, and user-friendly ways of installing and removing these items, especially when frequent adjustments or repositioning is desired.

Accordingly, a need exists for improved magnetic attachment assemblies that may be used in funeral settings to attach displays or other items onto casket lids in a secure yet easily detachable manner.

### SUMMARY

In one embodiment, a magnetic attachment assembly includes a display layer and a support layer having a front surface and a rear surface opposite the front surface, the support layer including a rear magnet provided on the rear surface, a stand attachable to the rear surface, and a pair of mounting apertures formed in the rear surface. The display layer is magnetically attachable to the front surface of the support layer.

In another embodiment, a casket assembly includes a body, a lid rotatably coupled to the body, the lid including an inner surface and a metal plate provided within the inner surface, and a magnetic attachment assembly including a display layer and a support layer having a front surface and a rear surface opposite the front surface, the support layer including a rear magnet provided on the rear surface, a stand extending from the rear surface, and a pair of mounting apertures formed in the rear surface. The display layer is magnetically attachable to the front surface of the support layer and the support layer is magnetically attached to the metal plate in the lid.

In yet another embodiment, a method for assembling a magnetic attachment assembly on lid of a casket is provided. The method includes positioning a front magnet within a front magnet recess of a support layer, magnetically attaching a display layer to a front surface of the support layer, securing a rear magnet to a rear surface of the support layer, securing a stand to the rear surface of the support layer, and magnetically attaching, by the rear magnet, the support layer to a metal plate provided within a lid of a casket.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a casket assembly including a magnet attachment assembly, according to one or more embodiments shown and described herein;

FIG. 2 schematically depicts a front exploded perspective view of the magnet attachment assembly, according to one or more embodiments shown and described herein;

FIG. 3A schematically depicts a rear perspective view of the magnet attachment assembly, according to one or more embodiments shown and described herein;

FIG. 3B schematically depicts an enlarged rear perspective view of circle 3B taken from FIG. 3A, according to one or more embodiments shown and described herein; and

FIG. 4 depicts a flowchart of an illustrative method for assembling the magnetic attachment assembly on a lid of a casket, according to one or more embodiments shown and described.

### DETAILED DESCRIPTION

Embodiments described herein are directed to a casket assembly that includes a body, a lid, and a magnetic attachment assembly for attaching an item onto an inner surface of the lid.

The magnetic attachment assembly includes a display layer and a support layer for attaching an item onto an inner surface of the lid to be presented when the lid is open relative to the body. Various embodiments of the magnetic attachment assembly and the operation of the magnetic attachment assembly are described in more detail herein. Whenever possible, the same reference numerals will be used throughout the drawings to refer to the same or like parts.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

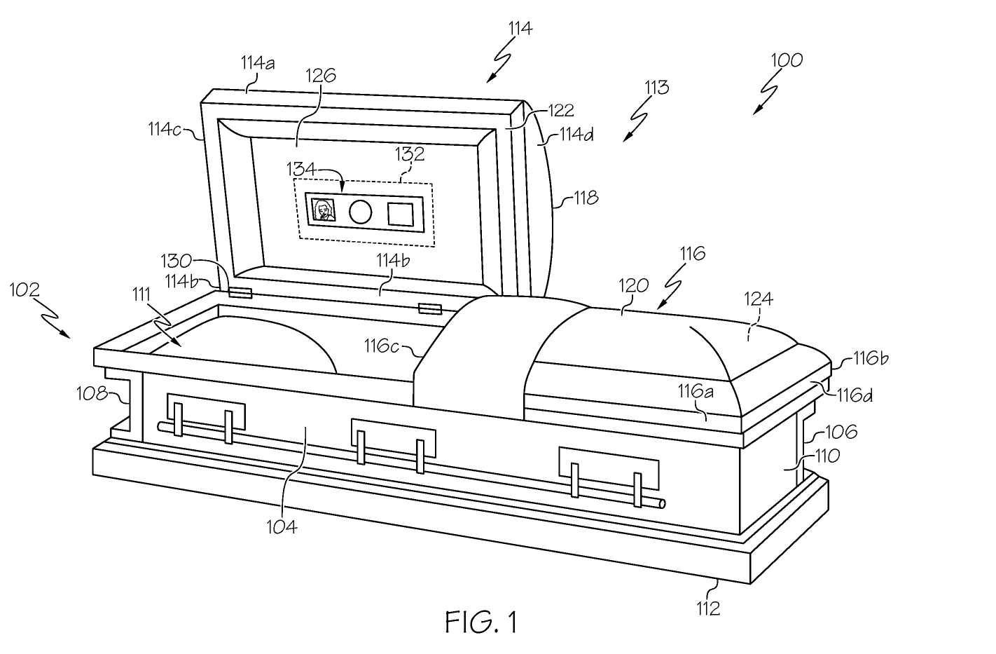

Referring now to FIG. 1, a casket assembly 100 is illustrated according to one or more embodiments described herein. The casket assembly 100 may generally include a body 102, a first lid 114, a second lid 116, and a magnetic attachment assembly 134. The body 102 includes a front wall 104, a rear wall 106 opposite the front wall 104, a head wall 108, a foot wall 110 opposite the head wall 108, and a base 112. The front wall 104 extends between the head wall 108 and the foot wall 110 and is connected to the base 112. The rear wall 106 also extends between the head wall 108 and the foot wall 110 and is connected to the base 112. The head wall 108 extends between the front wall 104 and the rear wall 106 and is connected to the base 112. The foot wall 110 similarly extends between the front wall 104 and the rear wall 106 and is connected to the base 112. The front wall 104, the rear wall 106, the head wall 108, and the foot wall 110 cooperate with the base 112 to define an open interior 111.

The lid 113 includes a lining 126, one or more hinges 130, and a metal plate 132. In embodiments, the lid 113 is a one-piece component. In other embodiments, the lid 113 is segmented to include the first lid 114 and the second lid 116. In such embodiments, the first lid 114 is located above a portion of the body 102. The first lid 114 has a first wall 114a, a second wall 114b, a third wall 114c, a fourth wall 114d, a first outer surface 118, and a first inner surface 122. The second lid 116 is also located above another portion of the body 102. The second lid 116 has a first wall 116a, a second wall 116b, a third wall 116c, a fourth wall 116d, a second outer surface 120, and a second inner surface 124.

The second wall 114b of the first lid 114 and the second wall 116b of the second lid 116 are connected to the rear wall 106 of the body 102 via the hinges 130. The hinges 130 allow the first lid 114 and the second lid 116 to rotate between a closed position and an open position relative to the body 102. Accordingly, the first lid 114 and the second lid 116 may rotate independent of one another.

As shown in FIG. 1, the first lid 114 is in the open position and the second lid 116 is in the closed position. When the first lid 114 is in the closed position, the first wall 114a of the first lid 114 is adjacent the front wall 104 of the body 102, the second wall 114b of the first lid 114 is adjacent the rear wall 106 of the body 102, the third wall 114c of the first lid 114 is adjacent the head wall 108 of the body 102, and the fourth wall 114d of the first lid 114 is over the base 112 of the body 102. Similarly, when the second lid 116 is in the closed position, the first wall 116a of the second lid 116 is adjacent the front wall 104 of the body 102, the second wall 116b of the second lid 116 is adjacent the rear wall 106 of the body 102, the third wall 116c of the second lid 116 is over the base 112 of the body 102, and the fourth wall 116d of the second lid 116 is adjacent the foot wall 110 of the body 102.

Referring still to FIG. 1, the first lid 114 includes the lining 126 shown in front of the first inner surface 122 of the first lid 114. The first lid 114 also includes the metal plate 132 positioned between the first inner surface 122 and the lining 126, and is mounted to the first inner surface 122, thus providing a location for magnetically attaching additional items. The metal plate 132 may be formed of steel or any other suitable magnetic material. As described in more detail herein, the magnetic attachment assembly 134 is magnetically attached to the metal plate 132 and may include components configured to hold displays or other accessories.

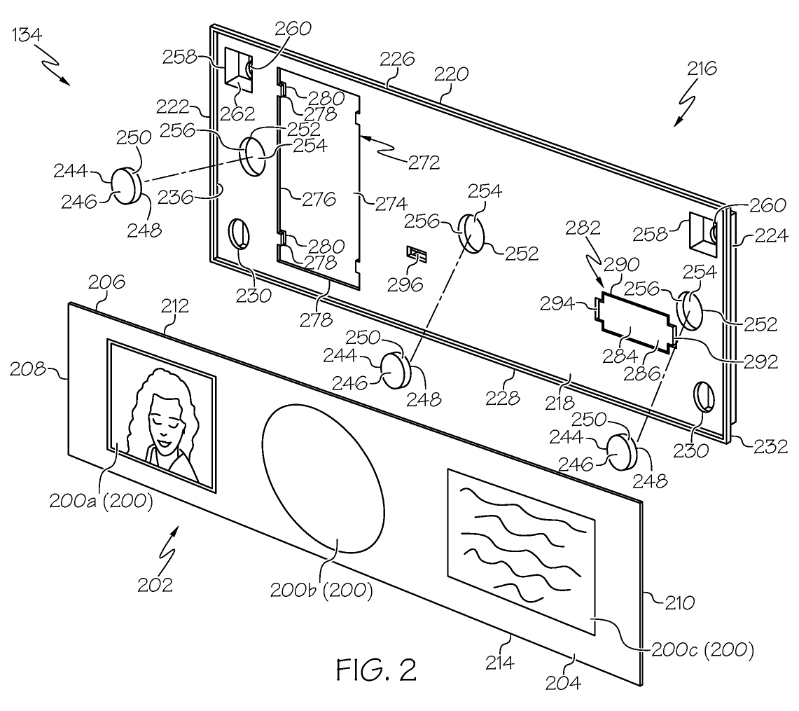

Referring now to FIG. 2, an exploded view of the magnetic attachment assembly 134 is illustrated as an embodiment configured to secure or display various components on the casket assembly 100 (FIG. 1). The magnetic attachment assembly 134 may include a display layer 202 and a support layer 216. The display layer 202 includes a display front surface 204, a display rear surface 206 opposite the display front surface 204, a display first side surface 208, a display second side surface 210 opposite the display first side surface 208, a display upper surface 212, and a display lower surface 214 opposite the display upper surface 212. The display front surface 204 extends between the display first side surface 208, the display second side surface 210, the display upper surface 212, and the display lower surface 214. The display rear surface 206 also extends between the display first side surface 208, the display second side surface 210, the display upper surface 212, and the display lower surface 214. The display layer 202 is positioned to present information or imagery on the display front surface 204. For example, the display layer 202 may include printed material 200 on a portion of the display front surface 204. The printed material 200 may be attached to the display front surface 204 in any suitable manner such as by being glued, bonded, or otherwise connected to the display layer 202. In embodiments, the printed material 200 fully covers the display front surface 204. In other embodiments, multiple separate pieces of printed material 200, such as printed material 200a, 200b, 200c, may be spaced apart from one other along the display front surface 204. It should be appreciated that the printed material 200 may be printed in any suitable manner. In embodiments, the printed material 200 may be UV printed. Additionally, in embodiments, the printed material 200 may be directly printed onto the display front surface 204 of the display layer 202 rather than being separately attached.

The support layer 216 is shown spaced apart from the display layer 202 in FIG. 2. The support layer 216 includes a support front surface 218, a support rear surface 220 opposite the support front surface 218, a support first side surface 222, a support second side surface 224 opposite the support first side surface 222, a support upper surface 226, and a support lower surface 228 opposite the support upper surface 226. The support front surface 218 extends between the support first side surface 222, the support second side surface 224, the support upper surface 226, and the support lower surface 228. The support rear surface 220 also extends between the support first side surface 222, the support second side surface 224, the support upper surface 226, and the support lower surface 228. In embodiments, the support first side surface 222 is a curved surface that extends between the support front surface 218 and the support rear surface 220. In embodiments, the support second side surface 224 is also curved and extends between the support front surface 218 and the support rear surface 220. In embodiments, the support upper surface 226 is also curved and extends between the support front surface 218 and the support rear surface 220. In embodiments, the support lower surface 228 is also curved and extends between the support front surface 218 and the support rear surface 220.

In embodiments, the support layer 216 includes a trim 232 formed along an outer perimeter of the support front surface 218 defined by the support first side surface 222, the support second side surface 224, the support upper surface 226, and the support lower surface 228. As shown, the trim 232 extends outwardly from the support front surface 218 in a direction opposite the support rear surface 220. In embodiments, the depth of the trim 232 is equal to a width of each of the display first side surface 208, the display second side surface 210, the display upper surface 212, and the display lower surface 214, so that the display layer 202 may be received within a boundary of the trim 232.

Still referring to FIG. 2, in embodiments, the support front surface 218 of the support layer 216 defines a support aperture 230. The support aperture 230 extends through the support layer 216. As shown in FIG. 2, a pair of support apertures 230 are formed in the support layer 216 extending through the support front surface 218 and the support rear surface 220. However, it should be appreciated that any number of support apertures 230 may be provided. The support apertures 230, as shown in FIG. 2, are formed in opposite corners of the support layer 216, although they may be placed in any other suitable location within the support layer 216. The support apertures 230 may be available to help handle the support layer 216, reduce weight of the support layer 216, allow viewing behind the support layer 216, or for other relevant reasons.

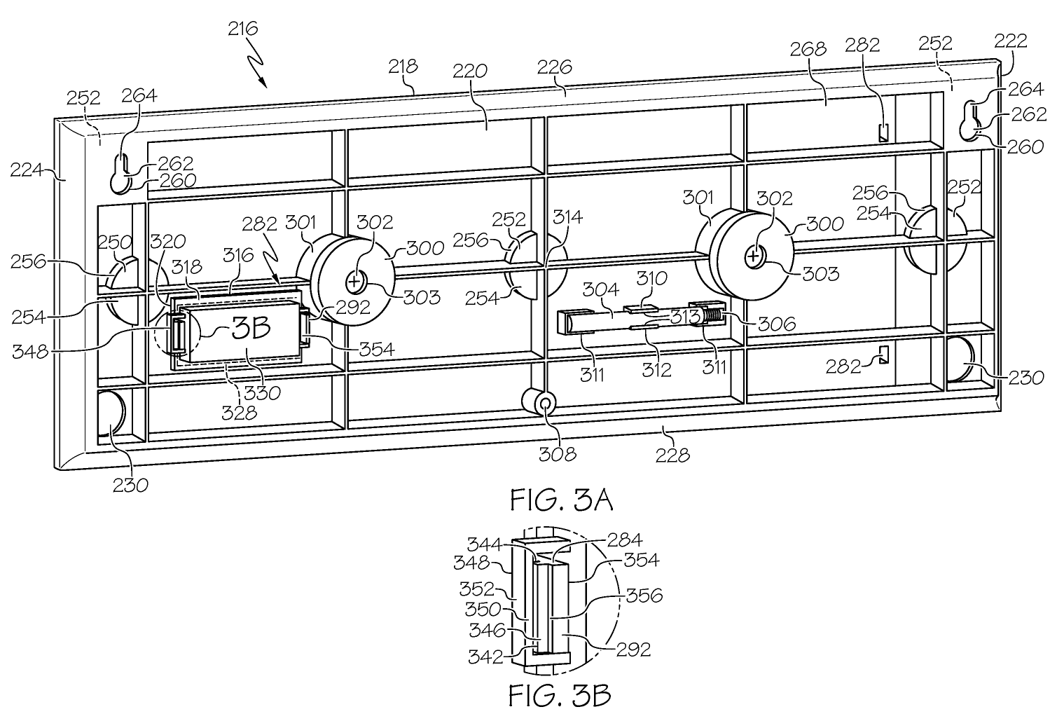

In embodiments, the support front surface 218 of the support layer 216 defines a front magnet recess 252 that includes a front magnet recess rear surface 254 and a front magnet recess side surface 256. As shown in FIG. 3A, the front magnet recess 252 protrudes in a direction of the support rear surface 220. Referring again to FIG. 2, a front magnet 244 is received in the front magnet recess 252. The front magnet 244 includes a front magnet front surface 246, a front magnet rear surface 248 opposite the front magnet front surface 246, and a front magnet side surface 250 extending between the front magnet front surface 246 and the front magnet rear surface 248. When the front magnet 244 is received in the front magnet recess 252, the front magnet front surface 246 is on the same plane as the support front surface 218, the front magnet rear surface 248 is adjacent the front magnet recess rear surface 254, and the front magnet side surface 250 is adjacent the front magnet recess side surface 256. Therefore, the front magnet front surface 246 is received within a boundary defined by the front magnet side surface 250. As shown in FIG. 2, the support layer 216 may include a plurality of front magnet recesses 252 formed in the support front surface 218 and a plurality of front magnets 244 with each front magnet 244 received within a respective front magnet recess 252. As shown, three front magnet recesses 252 and three front magnets 244 are provided. However, it should be appreciated that any number of front magnet recesses 252 and front magnets 244 may be provided. In embodiments, the front magnet recesses 252 and the front magnets 244 each have a circular shape. However, the front magnets 244 and front magnet recesses 252 may be formed in any other suitable shape. Also, as shown in FIG. 2, the plurality of front magnets 244 are arranged in a linear array extending between the support first side surface 222 and the support second side surface 224. However, the plurality of front magnet recesses 252 may be arranged in any suitable array or position along the support front surface 218.

Referring still to FIG. 2, in embodiments, the support front surface 218 of the support layer 216 defines a mounting recess 258 that includes a mounting aperture 260 formed within the mounting recess 258. As shown in FIG. 3A, the mounting aperture 260 passes through the support layer 216 and defines a wide opening 262 and a narrow opening 264 extending from the wide opening 262 in a direction opposite of the support lower surface 228. The mounting aperture 260 may be used to secure the support layer 216 to a surface with a mounting fastener. For example, a head of the mounting fastener may be initially inserted through the wide opening 262 such that a shaft of the mounting fastener is positioned within the narrow opening 264 when the magnetic attachment assembly is lowered relative to the mounting fastener, which may be fixed in a wall or other mounting surface. As shown in FIG. 2, the support layer 216 includes a plurality of mounting recesses 258, and each mounting recess 258 includes a mounting aperture 260. The mounting recesses 258, similar to the support apertures 230, as shown in FIG. 2, are located at corners of the support layer 216. However, the mounting recesses 258 may be formed at any suitable location within the support layer 216.

In embodiments, the support front surface 218 defines a first compartment 272 that includes a first compartment rear surface 274, a first compartment side surface 276, a finger 278, and a finger aperture 280. The first compartment rear surface 274 is on a plane parallel to the support front surface 218. The first compartment side surface 276 is normal to the first compartment rear surface 274 and the support front surface 218. The finger 278 extends inwardly from the first compartment side surface 276 in a direction normal to the first compartment side surface 276 and on the same plane as the support front surface 218. As shown in FIG. 2, the first compartment 272 may include a plurality of fingers 278 near corners of the first compartment 272, extending inwardly from vertical surfaces of the first compartment side surface 276 in a linear path relative to other fingers 278. The fingers 278 may also be arranged differently or not placed in a linear path. The finger apertures 280 are provided on the first compartment rear surface 274, correspond in location with a finger 278, and pass through the support layer 216. As shown in FIG. 2, each finger aperture 280 has a height and a width corresponding to a height and a width of a respective finger 278 and is positioned directly behind the respective finger 278. In use, the first compartment 272 is configured to retain pictures, panels, or similarly sized items, using the fingers 278. The finger apertures 280 may assist with air flow into the first compartment 272, permit visibility into the first compartment 272, or perform other functions. The fingers 278 and finger apertures 280 can also be produced in different sizes and placed in different locations around the first compartment 272 other than that depicted herein.

In embodiments, the support front surface 218 defines a stand aperture 296 formed in the support layer 216 and used to visibly determine whether a stand 304 (FIG. 3A) is being retained behind the support layer 216 or for other relevant purposes, as described in more detail herein.

Referring still to FIG. 2, in embodiments, the support front surface 218 of the support layer 216 defines a second compartment 282 that is spaced apart from the first compartment 272. The second compartment 282 includes a cover 284, a cover aperture 294, a second compartment shallow recess 316 (FIG. 3A), a perimeter seal 328 (FIG. 3A) inside of the second compartment shallow recess 316, a second compartment deep recess 330 (FIG. 3A), and a catch 348 (FIG. 3B). The second compartment 282 is in a closed position when the cover 284 is attached to the support layer 216 over the second compartment deep recess 330 and the cover 284 is compressing the perimeter seal 328 making the second compartment deep recess 330 a sealed compartment. The second compartment 282 is in an open position when the cover 284 is removed from the support layer 216 to expose the second compartment deep recess 330.

The cover 284 includes a cover front surface 286, a cover rear surface (not shown) opposite the cover front surface 286, a cover side surface 290, and an arm 292. When the cover is attached to close the second compartment 282, the cover front surface 286 is parallel to and flush with the support front surface 218, the cover rear surface is adjacent the perimeter seal 328, the arm 292 is received within the cover aperture 294, and the cover 284 is received within a boundary defined by the second compartment shallow recess 316. As shown in FIG. 2, the cover 284 may include a plurality of arms 292 extending from opposite sides of the cover side surface 290 and received within the respective cover aperture 294.

Referring again to FIG. 3A, a rear perspective view of the support layer 216 of the magnetic attachment assembly 134 is depicted. The second compartment 282 includes the second compartment shallow recess 316, the perimeter seal 328, the second compartment deep recess 330, and the catch 348. The second compartment shallow recess 316, the second compartment deep recess 330, and the catch 348 each extend outwardly from the support rear surface 220. The catch 348 extends further than the second compartment shallow recess 316, and the second compartment deep recess 330 extends further than the catch 348. The catch 348 includes a catch rear surface 350 and a catch side surface 352 (FIG. 3B). The second compartment shallow recess 316 includes a shallow recess rear surface 318 and a shallow recess side surface 320. The perimeter seal 328 is inside the second compartment shallow recess 316, adjacent the shallow recess rear surface 318, and positioned in a perimeter around the opening of the second compartment deep recess 330. When the second compartment 282 is closed by the cover 284, the cover rear surface of the cover 284 is adjacent the perimeter seal 328 and the shallow recess side surface 320 is adjacent the cover side surface 290 (FIG. 2).

Now referring to FIG. 3B, the arm 292 of the cover 284 includes an arm first side 354, an arm second side 356 opposite the arm first side 354, and a retention tab 342 extending outwardly from the arm second side 356. The arm first side 354 is proximal to the cover rear surface, and the arm second side 356 is distal to the cover rear surface. The retention tab 342 includes a retention tab front surface 344 and a retention tab rear surface 346 opposite the retention tab front surface 344. The retention tab front surface 344 is a flat surface normal to the arm 292 and parallel to the cover front surface 286 and the cover rear surface, and the retention tab rear surface 346 is opposite the retention tab front surface 344. The arm 292 may be flexible in directions normal to the arm first side 354 and normal to the arm second side 356. When the second compartment 282 is in the closed position, the retention tab front surface 344 is adjacent the catch rear surface 350, and the arm 292 extends out from the support rear surface 220 farther than the catch 348 but not as far as the second compartment deep recess 330. To open the second compartment 282, the arm 292 can be flexed inward toward the second compartment 282 until the retention tab 342 fits inside the cover aperture 294, after which the arm 292 may be pulled through the cover aperture 294 so the cover 284 can be removed.

Referring again to FIG. 3A, the rear magnet 300 is positioned adjacent the rear magnet protrusion 301. The rear magnet 300 and the rear magnet protrusion 301 each include a threaded hole 303 that accommodates a rear magnet fastener 302. The rear magnet protrusion 301 extends outward from the support rear surface 220. As shown in FIG. 3A, the rear magnet 300 and the rear magnet protrusion 301 have similar cylindrical shapes with similar diameters. Also shown in FIG. 3A, the support layer 216 may include a plurality of rear magnets 300 and a plurality of rear magnet protrusions 301, each having the threaded hole 303 and each receiving the rear magnet fastener 302 securing the rear magnets 300 to a respective rear magnet protrusion 301. The rear magnets 300 in FIG. 3A are arranged along a horizontal line, though a plurality of rear magnets 300 may also be positioned along a vertical line, angled line, or any other suitable position.

Still referring to FIG. 3A, the stand 304 may be used to position the support layer 216 on a surface. The stand 304 includes a threaded end 306, and the threaded end 306 of the stand 304 threadedly engages the stand threaded hole 308 provided in the support layer 216. The stand retainer 310 is configured to house the stand 304 when it is not in use. The stand retainer 310 includes protrusion caps 311 and protrusions 312. Each protrusion cap 311 extends outwardly from the support rear surface 220 and is adjacent an end of the stand 304 when retained. As shown in FIG. 3A, each protrusion cap 311 may surround each end of the stand 304, conforming to the shape of that end. A pair of protrusions 312 also extends outwardly from the support rear surface 220 adjacent the stand 304, one protrusion 312 on one side of the stand 304, and another protrusion 312 on another side of the stand 304. Each protrusion 312 includes a protrusion retention tab 313 that extends from a side of the protrusion 312 adjacent the stand 304. As shown in FIG. 3A, the width of the stand 304 is slightly less than the distance between the protrusions 312, and the distance between the protrusion retention tabs 313 is slightly less than the width of the stand 304, ensuring that the stand 304 remains retained in the stand retainer 310. Specifically, the stand 304 is retained between the protrusion caps 311, between the pair of protrusions 312, and between the support rear surface 220 and the protrusion retention tabs 313. The protrusion retention tabs 313 are flexible enough that, with sufficient force, the protrusions 312 may flex apart, to receive the stand 304 when inserted therebetween and to release the stand 304 when removed from the stand retainer 310.

A support grid 314 extends outwardly from the support rear surface 220 to the same distance as the rear magnet protrusions 301 and the mounting recesses 258. As shown in FIG. 3A, the support grid 314 forms a perimeter along the support first side surface 222, the support second side surface 224, the support upper surface 226, and the support lower surface 228. The support grid 314 forms a grid of horizontal and vertical protrusions from the support rear surface 220. In other embodiments, this support grid 314 may form angled protrusions.

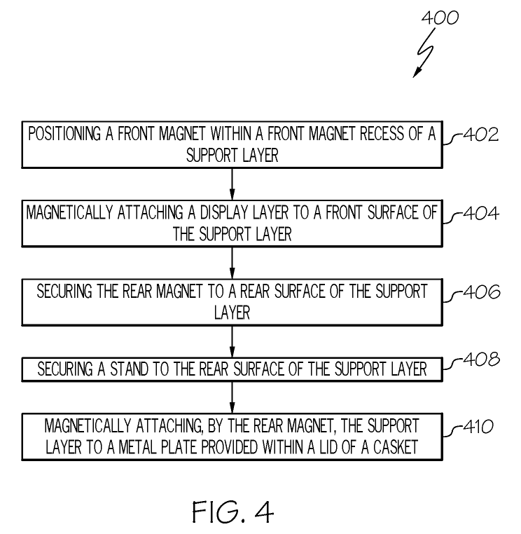

Referring now to FIG. 4, and with reference to FIGS. 1-3B, a method 400 for assembling the magnetic attachment assembly 134 is illustrated. At step 402, the front magnet 244 is positioned within the front magnet recess 252 of the support layer 216. In embodiments, in which the magnetic attachment assembly 134 includes a plurality of front magnet recesses 252 formed in the support layer 216, a plurality of front magnets 244 are received within respective front magnet recesses 252. At step 404, the display layer 202 is magnetically attached to the support front surface 218 of the support layer 216. At step 406, the rear magnet 300 is secured to the rear magnet protrusion 301 via rear magnet fasteners. In embodiments in which the magnetic attachment assembly 134 includes a plurality of rear magnet protrusions 301 formed in the support layer 216, a plurality of rear magnets 300 are secured to respective rear magnet protrusions 301. At step 408, the stand 304 is retained within the stand retainer 310. At step 410, the support layer 216 is magnetically attached to the metal plate 132 provided within the first lid 114 of the casket assembly 100. In situations in which the magnetic attachment assembly 134 is to be removed from the first lid 114 and put on display, the stand 304 is removed from the stand retainer 310 and secured to the stand threaded hole 308 such that the magnetic attachment assembly 134 may be supported on a surface in an upright position.

From the above, it is to be appreciated that defined herein is a casket assembly for presenting an image. The casket assembly includes a body, a lid, and a magnetic attachment assembly for attaching the image onto a surface. The magnetic attachment assembly includes a display layer and a support layer for attaching an item onto a surface of a lid of the casket assembly to be displayed. This design allows for the presentation of an item in multiple ways on surfaces that may be difficult to present an item and for the interchangeability of these items.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A magnetic attachment assembly comprising:
a display layer; and
a support layer having a front surface and a rear surface opposite the front surface, the support layer including:
a rear magnet provided on the rear surface;
a stand attachable to the rear surface; and
a pair of mounting apertures formed in the rear surface,
wherein the display layer is magnetically attachable to the front surface of the support layer.

2. The magnetic attachment assembly of claim 1, further comprising a first compartment provided in the front surface of the support layer, the first compartment including a finger extending inwardly from a side surface of the first compartment.

3. The magnetic attachment assembly of claim 1, further comprising a second compartment provided in the front surface of the support layer, the second compartment including a cover provided over the second compartment.

4. The magnetic attachment assembly of claim 1, wherein the mounting apertures are formed within support recesses in the support layer.

5. The magnetic attachment assembly of claim 1, wherein the front surface of the display layer includes UV printed material.

6. The magnetic attachment assembly of claim 1, further comprising:
a front magnet recess formed within the front surface of the support layer; and
a front magnet received within the front magnet recess.

7. The magnetic attachment assembly of claim 6, wherein the front magnet recess includes a plurality of recesses and the front magnet includes a plurality of magnets.

8. The magnetic attachment assembly of claim 1, further comprising a threaded hole formed in the rear surface of the support layer and a threaded end of the stand that engages the threaded hole.

9. The magnetic attachment assembly of claim 1, further comprising a stand retainer formed in the rear surface of the support layer.

10. The magnetic attachment assembly of claim 9, wherein the stand retainer includes protrusions extending opposite the rear surface of the support layer.

11. The magnetic attachment assembly of claim 1, wherein the rear magnet includes a plurality of magnets.

12. A casket assembly comprising:
a body;
a lid rotatably coupled to the body, the lid including an inner surface and a metal plate provided within the inner surface; and
a magnetic attachment assembly comprising:
a display layer; and
a support layer having a front surface and a rear surface opposite the front surface, the support layer including:
a rear magnet provided on the rear surface;
a stand extending from the rear surface; and
a pair of mounting apertures formed in the rear surface,
wherein the display layer is magnetically attachable to the front surface of the support layer, and
wherein the support layer is magnetically attached to the metal plate in the lid.

13. The casket assembly of claim 12, further comprising a first compartment provided in the front surface of the support layer, the first compartment including a finger extending inwardly from a side surface of the first compartment.

14. The casket assembly of claim 12, further comprising a second compartment provided in the front surface of the support layer, the second compartment including a cover provided over the second compartment.

15. The casket assembly of claim 12, wherein the mounting apertures are formed within support recesses in the support layer.

16. The casket assembly of claim 12, wherein the front surface of the display layer includes UV printed material.

17. The casket assembly of claim 12, further comprising:
a front magnet recess formed within the front surface of the support layer; and
a front magnet received within the front magnet recess.

18. A method comprising:
positioning a front magnet within a front magnet recess of a support layer;
magnetically attaching a display layer to a front surface of the support layer;
securing a rear magnet to a rear surface of the support layer;
securing a stand to the rear surface of the support layer; and
magnetically attaching, by the rear magnet, the support layer to a metal plate provided within a lid of a casket.

19. The method of claim 18, further comprising:
magnetically detaching the support layer from the metal plate;
removing the stand from a stand retainer formed in the rear surface of the support layer; and
threadedly engaging a threaded end of the stand with a threaded hole formed in the rear surface of the support layer.

20. The method of claim 18, further comprising receiving rear magnet fasteners engaged with the lid within mounting apertures formed in the rear surface.
